(19) United States
(12) Patent Application Publication
(10) Pub. No.: US 2004/0007887 A1
(43) Pub. Date: Jan. 15, 2004

(54) Extendable handle for a manually operated implement and method

(76) Inventor: Olin L. Elliott, Greenville, SC (US)

Correspondence Address: Ralph Bailey, RALPH BAILEY, P.A., 125 Broadus Avenue, Greenville, SC, 29601, US

(21) Appl. No.: 10/607,490

(22) Filed: Jun. 25, 2003

Related U.S. Application Data
(63) Continuation-in-part of application No. 09/607,308, filed on Jun. 29, 2000, now Pat. No. 6,598,266.

(51) Int. Cl. A01B 1/22; B25G 1/06

(52) U.S. Cl. 294/58; 294/25

(57) ABSTRACT

A handle and method for use with a manually operated implement including an elongated tubular frame (A) with a holder (B) at one end for receiving a shank portion of the implement against rotation and movement in and out with respect to the holder and for achieving a two-point control by the user through a slidable support (C) opposite the holder and an intermediate upright hand grip (D), a strap (E) carried by a support (C) being provided for encompassing an arm of the user just below the elbow facilitating the application of force upwardly and downwardly as well as in and out through the implement. A second single straight length of tubing (F) has a holder for attachment to the frame and a second holder for attachment of a selected implement.

This is a continuation-in-part of my co-pending application entitled HANDLE FOR A MANUALLY OPERATED IMPLEMENT AND METHOD, Ser. No. 09/607,308, Filed Jun. 29, 2000.

### BACKGROUND OF THE INVENTION

This invention relates to a handle for facilitating manual operation of a variety of tools or implements including those relating to gardening and household tasks and method. The invention further contemplates an extendable garden tool capable of interchangeably accommodating a variety of implements or second single straight lengths of tubing having an aligned shank for the improved performance of a manually operated garden implement.

The prior art is exemplified by U.S. Pat. Nos. 5,813,206 and 5,937,627, both of which relate to handles or holders for gardening implements providing enhanced leverage capabilities through the use of an elongated frame having an implement holder on one end and a stirrup resting on the wrist or forearm at the other end and including a handle grip carried by the frame intermediate its ends.

The gardening tool of the patents is only capable of exerting a downward force for digging and raking, utilizing an implement disposed at substantially right angles to the frame. The stirrup rests on the forearm just above the wrist. A leveraged force is developed when the implement is forcefully moved downwardly into the ground. No provision is made to facilitate the application of an upward force, or for aiding in the application of a force for pushing and pulling, or for rotating the implement or for applying a force at an angle to the horizontal since the stirrup is only capable of applying a force in one direction. No provision is made for utilizing a hollow frame member for receiving an implement shank so that use of a chuck for holding the shank of the tool is necessitated. A relatively heavy expensive chuck would be required for effectively positioning a tool. Moreover, adjustment of the longitudinal positioning of the stirrup is impossible because of its integral mounting on the frame. Therefore, the length of the lever arm through which force is multiplied is limited by the fixed positioning of the stirrup adjacent the wrist.

The gardening tools of the prior art are of fixed length. Being of fixed length, these tools require a user to squat, stoop, or otherwise position themselves on the ground to use the tool. Such squatting, stooping or positioning is extremely difficult, if not impossible, for older or disabled users who are incapable of assuming the bodily contortions required to use these tools. The problem therefore, is to provide extendibility while making it possible to interchange a great variety of different tools at fixed or extended lengths.

The prior art further includes U.S. Pat. Nos. 712,843, 2,482,589, 2,710,571, 4,888,846, and 5,529,357.

### SUMMARY OF THE INVENTION

Accordingly, it is an important object of the invention to provide a handle or holder for improving the performance of a manually operated implement by providing an elongated frame having an implement holder at one end and an arm support at the other end for engaging the arm of a user just below the elbow, and including a hand grip intermediate the implement on one end and the arm support on the other. By engaging the arm just below the elbow a lever arm is provided increasing the force that may be imparted to the implement.

Another important object of the invention is to provide a tool holding device or handle which will be ergonomically suited to use in gardening and in other household and general work applications involving the manual use of an implement or tool.

Another important object of the invention is to provide a handle for a manually operated implement which is versatile in that a wide variety of tools or implements may be positioned on one end of an elongated frame for receiving leveraged forces exerted from two-point securement by the hand and adjacent the elbow of the user.

Another important object of the invention is to permit the application of leveraged force to the work through an implement carried by the handle in any direction through the center line of the handle.

Another important object of the invention is to provide for a two-point control of a manually operated tool through the hand and forearm of the user who may exert increased forces through manipulation by either the left or right hand.

Still another important object of the invention is to provide for both pushing and pulling motions through a tool with a handle which affords a two-point control through the hand and arm of the user with enhanced leverage for multiplying the forces exerted by the user.

Another object of the invention is to provide a light weight, generally hollow inexpensive handle for manual tool manipulation utilizing a generally tubular section closed on at least three sides.

Another object of the invention is to facilitate the attachment of a wide variety of tools having multi-faceted shanks carried within a longitudinal bushing having a complimentary interior surface acting as stops for fixing the shank against rotation within one end of a frame having an elongated member with a circular cross-section.

Yet another object of the invention is to provide suitable means for limiting longitudinal movement of a variety of tool shanks and to permit a selected tool angle with respect to the longitudinal axis of the frame.

Still another important object of the invention is to provide an extendable handle ergonomically suited for use in gardening and in other household and general work applications involving the manual use of interchangeable implements.

Yet another important object of the invention is to facilitate the interchangeable attachment of a wide variety of manually operated implements and or second single straight lengths of tubing into one end of an extendable handle.

Another important object of the invention is to provide an extendable handle for manually operated implements in which a wide variety of implements may be interchangeably positioned on one end of a second single straight length of tubing carried by the handle.

Still another important object of the invention is to provide for both pushing and pulling motions through an extendable handle which affords two-point control through the hand and arm of the user with enhanced leverage for multiplying the forces exerted by the user, wherein the extended handle receives the exerted leveraged forces through the two-point securement of the handle at the hand and adjacent the elbow of the user.

Accordingly, it is an important object of the invention to provide an extendable handle for a manually operating an implement with an aligned shank capable of interchangeably accommodating a variety of manually operated implements or second single straight lengths of tubing having an aligned shank by providing a first single straight length of tubing having a circular cross section forming an elongated frame, a first holder at one end of the elongated frame in spaced relation to the implement for removably securing a first aligned shank of a selected implement to the handle, an upright hand grip carried by the frame intermediate the first holder and support for gripping by the hand of a user, an arm receiving apparatus carried by the elongated frame in longitudinal alignment with the hand grip for restraining the arm adjacent and below the elbow of the user against movement up and down with respect to the frame, a second straight length of tubing forming an extension member, a second holder at one end of the second straight length of tubing for receiving and removably securing the shank of a selected implement thereto, and a second aligned shank at the other end of the second straight length of tubing for removably securing the second straight length of tubing to the elongated frame, whereby the arm receiving apparatus is fixed in axial alignment with the arm for exerting an axial force on the implement without the necessity of tightly gripping the upright hand grip by the hand of the user, while avoiding the use of multiple telescoping frames for adjustment, and whereby interchangeable implements are selectively secured at extended positions on the elongated frame.

### BRIEF DESCRIPTION OF THE DRAWINGS

The construction designed to carry out the invention will be hereinafter described, together with other features thereof.

The invention will be more readily understood from a reading of the following specification and by reference to the accompanying drawings forming a part thereof, wherein an example of the invention is shown and wherein:

FIG. 1 is a left perspective view illustrating a handle for manually operating a rake implement having an elongated aligned shank wherein a two-point control of the implement is achieved utilizing an elongated frame holding the rake at one end and an arm engaging support at the other end for securement to the arm of the user just below the elbow constructed in accordance with the invention;

FIG. 2 is a side elevation further illustrating the apparatus constructed in accordance with the invention;

FIG. 3 is front elevation of the frame and handle illustrating a bushing having a circular outside surface and a hexagonal interior surface adapted to be press fitted into an open end of the frame;

FIG. 3-A is a side elevation further illustrating the bushing of FIG. 3;

FIG. 4 is an end view looking toward the right-hand end of FIG. 2 illustrating a strap for engaging an encircling the forearm of the user just below the elbow;

FIG. 5 is a side elevation of the frame illustrating the use of an implement in the form of a hoe;

FIG. 6 is a perspective view illustrating a trowel implement having a hexagonal shank suitable for reception within the holder at an open end of the frame;

FIG. 7 is a perspective view illustrating the apparatus constructed in accordance with the invention equipped with a trowel implement for a two-point control by the user and wherein an intermediator hand grip is tilted slightly forwardly to improve the ergonomics of the handle over extended periods of use;

FIG. 8 is a right perspective view illustrating a handle extended with a second single straight length of tubing constructed in accordance with the invention for manually operating a trowel implement having an elongated aligned shank wherein the implement is removably secured in one end of the second single straight length of tubing and the opposite end of the second single straight length of tubing is removably secured to the handle;

FIG. 9 is a left perpective view illustrating a connection member comprising a hexagonal shank carried by the second single straight length of tubing of FIG. 8 suitable for reception within a holder; and

FIG. 10 is a front perspective view illustrating a bushing having a circular outside surface and a hexagonal interior surface adapted to be press fitted into an open end of the second single straight length of tubing of FIG. 8.

FIG. 11 is a left front perspective view illustrating a seated user operating a handle extended with a second single straight length of tubing constructed in accordance with the invention for permitting the user to manually operate a trowel implement having an elongated aligned shank from a seated position off the ground.

### DESCRIPTION OF A PREFERRED EMBODIMENT

The drawings illustrate an extendable handle for a manually operating an implement with an aligned shank having an elongated frame A which preferably includes a hollow tubular structural shape. A holder B at one end of the elongated frame has a multi-faceted internal surface providing stops for engaging an implement shank having a multi-faceted external surface against rotation and for angular adjustment of the implement about a longitudinal axis. A support C is carried by the elongated frame on a portion of the elongated frame opposite the implement. An upright hand grip D is carried intermediate the ends of the elongated frame in spaced relation to the implement for gripping by the hand of a user. An arm receiving member E is carried by the support for engaging and encircling the arm adjacent the elbow. The handle is thus engagable at multiple locations by the user. A second single straight length of tubing F is carried by the elongated frame A for extending the useful length of the handle and the attached implement, enabling tasks that normally require bending or stooping to be performed from a sitting or standing position.

The elongated frame A is constructed from a structural selection preferably of a first single length of tubular aluminum. While dimensions are not critical, a suitable frame length may be approximately 15 inches long and having a 1.05 inch outside diameter. A second piece of tubular aluminum approximately 4 inches long may have an outside diameter of 0.75 inches for utilization as a hand grip D. The hand grip D is welded at an angle extending slightly forward in relation to the frame for comfortable prolonged use at approximately 3 inches from an open end of the frame. The hand grip D may include a handle bar or cushion 10 as illustrated in the drawings.

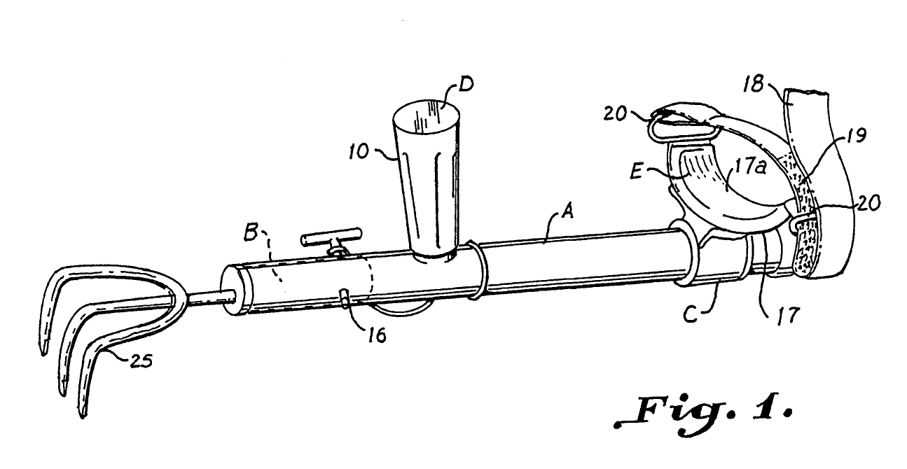

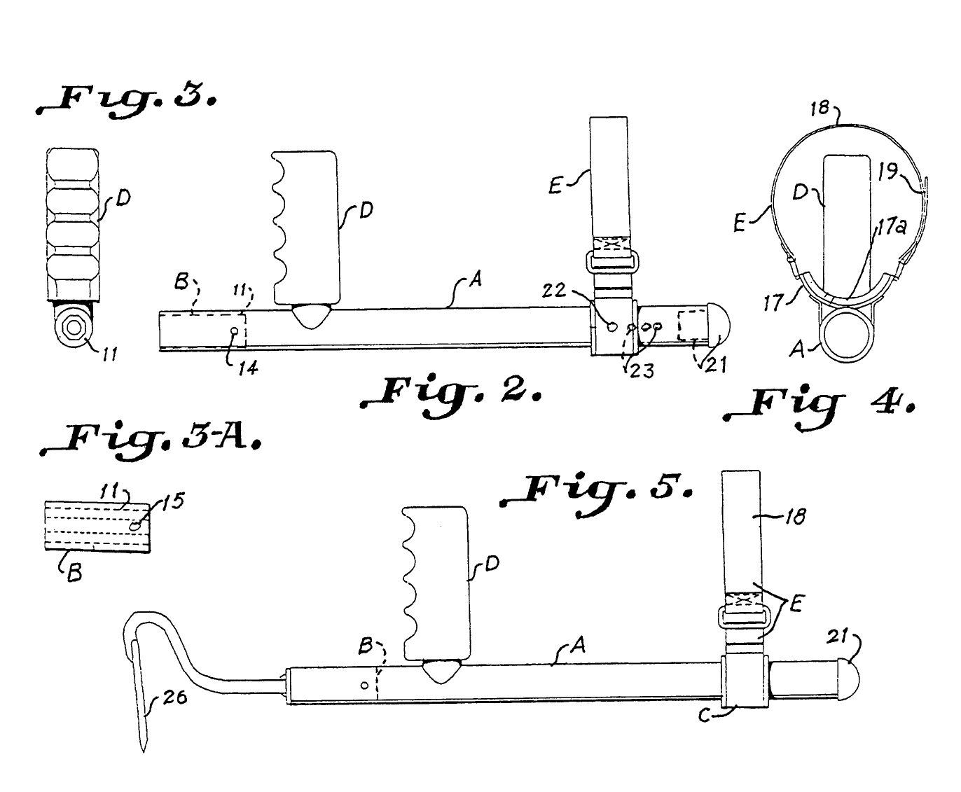

A holder B includes a bushing 11 illustrated in FIG. 3-A which may be press fitted in the open end of the elongated frame. Each of the implements adapted for use with the apparatus preferably includes an elongated shank 12 having an hexagonal outer surface adapted to be received within a complementary inner surface of the bushing 11. The shank 12 is equipped with a pin receiving opening 13 (FIG. 6) on each of the respective longitudinal facets adapted for transverse alignment with an opening 14 within the tubular frame and extending through the sleeve as illustrated as at 15 in FIG. 3-A. An interlocking pin apparatus 16 is provided for reception by transversly aligned openings 13, 14 and 15 as shown in FIG. 1.

A support C that is preferably slidable on the frame A, comprises a ring of suitable material such as nylon. The ring is carried on the elongated tube, being slidable on the greater part of the tube remote from the tool. The tool is illustrated as a rake 25 in FIG. 1. The ring has an arm rest 17 preferably provided with a cushion 17a and arm strap 18 to encircle the forearm just below and adjacent to the elbow. The strap 18 is provided with a suitable fastener such as velcro 19 on a suitable length of strap at least one end for providing opposed velcro fastening surfaces. The strap is carried on the free ends of the arcuate arm rest on the loops 20. A transverse pin (not shown), that may be similar to the pin 16, may be passed through a transverse opening 22 in the ring C and a selected opening of the aligned openings 23 in the frame, as shown in FIG. 2. The assembly provides fixed positioning for accommodating the users arm affording maximum length to the lever arm afforded by the frame. However, the handle can be used without the support C being pinned in place, but allowed to slide freely. The strap can be pulled tight or left slightly loose as the user desires.

By utilizing the strap and arm rest for encircling the arm the handle provides a complete stabilized unit in relation to the working head of the tool or implement and aids in multiplying the work force in all directions, i.e., up, down, or left and right as well as back and forth.

The handle grip and the support including the arm strap provide the two-point control of the tool carried by the handle.

A plug 21 in the rear of the tube keeps the slide ring from coming off of the frame and provides a smooth rounded end facilitating two handed use for particularly difficult digging.

Second single straight length of tubing F is preferably constructed from a structural selection of a second single length of tubular aluminum. The second single straight length of tubing further includes connection members 30 and 34 positioned at opposite ends of the second single straight length of tubing. Connection member 30 is preferably constructed of an elongated shank 32 having a hexagonal outer surface adapted to be received within the complementary hexagonal internal surface of the bushing 11 within the holder B on the elongated frame A. The shank 32 is equipped with a pin receiving opening as similarly illustrated at 15 in FIG. 3-A. An interlocking pin apparatus 16 is provided for reception by the pin receiving opening as similarly illustrated in FIG. 1.

Connection member 34 is preferably constructed of a bushing 36 which may be press fitted in the open end of the second single straight length of tubing opposite connection member 32. Bushing 36 preferably includes a hexagonal internal surface adapted to receive a complimentary hexagonal outer surface of an implement shank 12 or additional second single straight length of tubing shank 32. Connection member 34 is equipped with a pin receiving opening positioned adjacent bushing 36 and extending through the second single straight length of tubing F for receiving interlocking pin apparatus 16. Interlocking pin apparatus 16 extends through the second single straight length of tubing F via the pin receiving opening to engage an implement shank 12 or second single straight length of tubing shank 32 within bushing 36 of connection member 34 on second single straight length of tubing F as similarly illustrated in FIG. 1. for removably securing the implement to the second single straight length of tubing F.

The second single straight length of tubing F extends the useful length of the elongated frame A of the handle, enabling tasks that normally require bending, stooping, or kneeling upon the ground to be done from a sitting or standing position as illustrated in FIG. 11. As one skilled in the art will recognize, however, a plurality of second single straight lengths of tubing may be coupled together in the manner set forth herein to extend the useful reach of the handle so that the full use of the handle and attached implement may be realized from a sitting or standing position and adjusted as desired. This capability is especially advantageous for handicapped persons confined to a wheelchair or older persons with limited mobility.

The particular implement to be used with the handle is preferably equipped with a hexagonal shank for insertion into the complimentary bushing opening. The matching hexagonal shapes act as stops keep the tool from rotating within the bushing. It will also allow the tool to be adjustably positioned every 45 degrees around the end of the tube or in six different planes in relation to the hand grip. Intersecting holes 15 are drilled through the tool shank to align with the hole 14 in the handle. This allows a pin 16 preferably with a T-handle to be run through the handle and the mandrel of the tool at all possible positions to fix the tool securely in the handle against both pushing and pulling motions. This configuration of the through pin 16 is preferred because it is the easiest to use, and most positive in application.

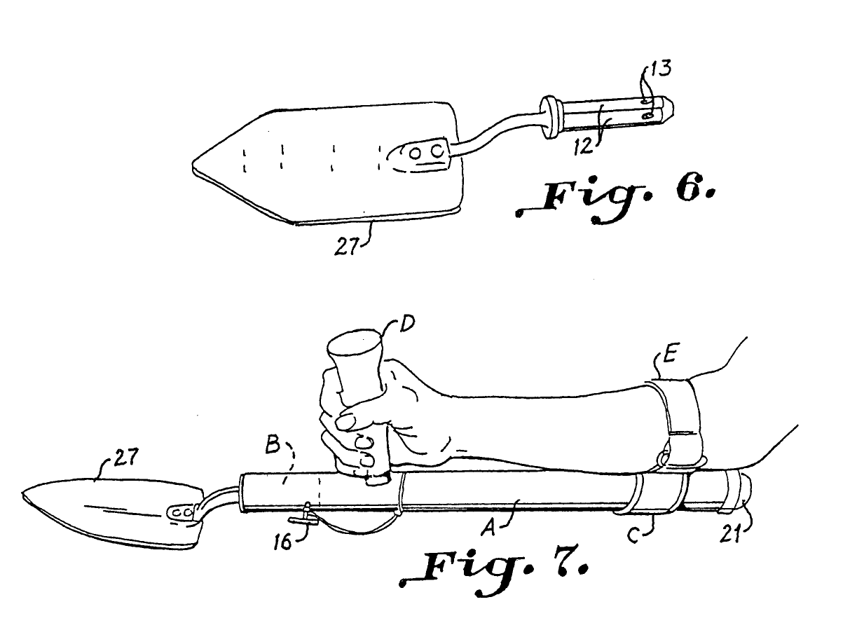

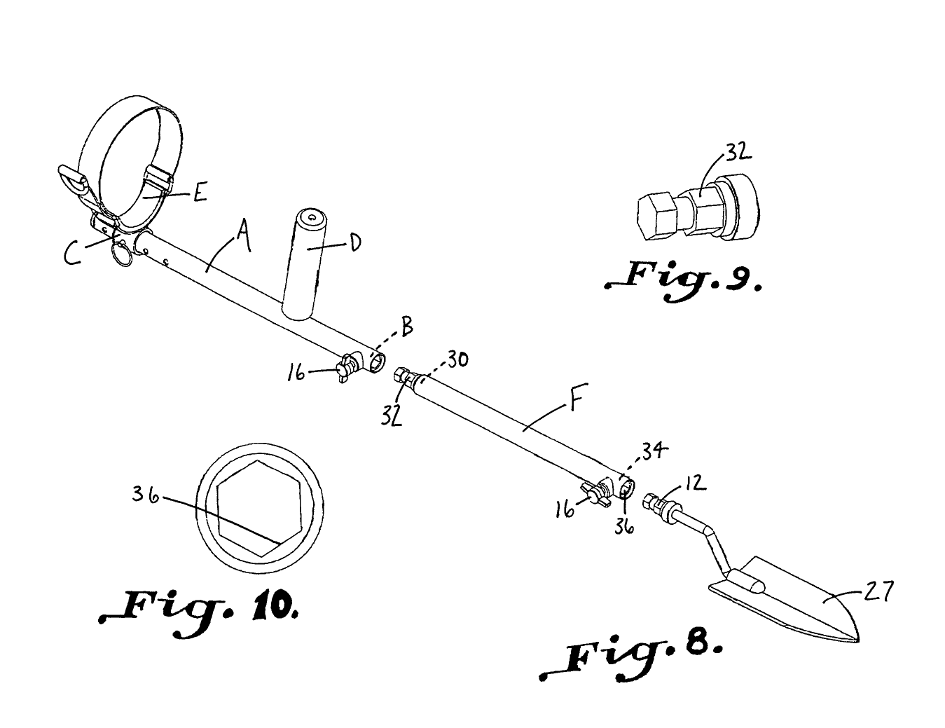

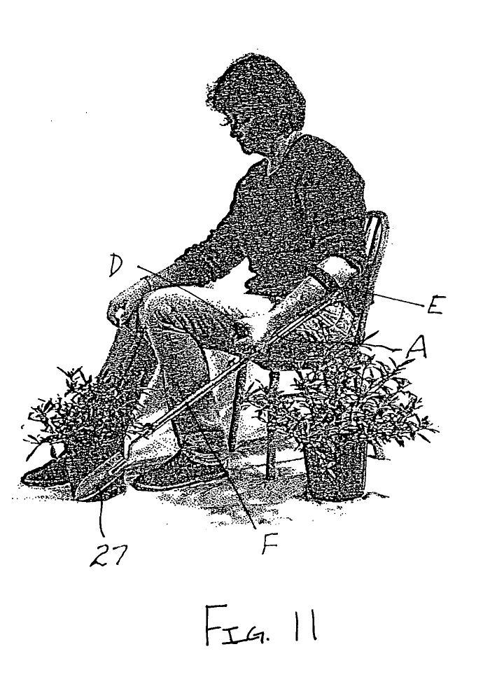

The apparatus described makes the tool and the handle one working unit for the duration of the use of that particular tool. A variety of tools all with the same shank configuration should be available for use with the handle as illustrated as a rake 25 in FIG. 1, a hoe 26 in FIG. 5 and a trowel 27 in FIGS. 6 and 7.

Hand tools are often equipped with one basic type of handle. Round or formed shapes which are gripped with the entire hand while using the tool are common. The pressures of the use of the tool are all directly passed to the fingers and wrist. The thumb is particularly subject to stress.

Handles constructed in accordance with the invention do not require that the fingers maintain a grip on the handle. The fingers do not have to grip tightly to control the tool and the pressures of the work are transferred to the arm hand unit and the wrist and thumb are relieved of much of their accustomed stress.

Any of a considerable variety of tool shapes and purposes can be made for use with the tool holding devices of the invention. It is thought that this system will be especially useful in gardening tools. However, industrial tools and law enforcement devices also may be considered as potential applications using different tools or implements as may be useful with the strap encircling the arm just below the elbow facilitating control of this implement.

While a preferred embodiment of the invention has been described using specific terms, such description is for illustrative purposes only, and it is to be understood that changes and variations may be made to the extendable handle for a manually operated implement constructed in accordance with the invention, that by engaging a second single straight length of tubing extends the useful length of the elongated frame of the handle enabling tasks that normally require bending, stooping, or kneeling upon the ground to be performed while sitting or standing, its parts, and methods of manufacture, without departing from the spirit or scope of the following claims.

What is claimed is:

1. An extendable handle for use on a variety of manually operated implements each having an aligned shank, comprising:
a first single straight length of tubing having a circular cross section forming an elongated frame;
a first holder at one end of the elongated frame in spaced relation to the implement for removably securing a first aligned shank of a selected implement to the handle;
an upright hand grip carried by the frame intermediate the first holder and support for gripping by the hand of a user;
an arm receiving apparatus carried by the elongated frame in longitudinal alignment with the hand grip for restraining the arm adjacent and below the elbow of the user against movement up and down with respect to the frame;
a second straight length of tubing forming an extension member;
a second holder at one end of the second straight length of tubing for receiving and removably securing the shank of a selected implement thereto; and
a second aligned shank at the other end of the second straight length of tubing for removably securing the second straight length of tubing to the elongated frame,
whereby the arm receiving apparatus is fixed in axial alignment with the arm for exerting an axial force on the implement without the necessity of tightly gripping the upright hand grip by the hand of the user, while avoiding the use of multiple telescoping frames for adjustment, and whereby interchangeable implements are selectively secured at extended positions on the elongated frame.

2. The handle set forth in claim 1, wherein the selected implement is a garden tool.

3. The handle set forth in claim 1, further including a support carried by the elongated frame encircling the the single length of tubing adjacent to the other end of the elongated frame opposite the implement for longitudinal sliding movement on the frame for positioning the support for facilitating engagement of the upright handgrip of the user.

4. The handle set forth in claim 3, wherein the support is longitudinally slidable on the frame.

5. The handle set forth in claim 3, further including an interlocking apparatus between the support and the frame for fixing the support in longitudinally adjusted position on the frame.

6. The handle set forth in claim 3, including a transverse member extending through a transverse opening in the support and engaging the frame fixing the support in an adjusted position on the frame.

7. The handle set forth in claim 1, wherein the hand grip is inclined slightly forwardly toward the implement for the comfort of the user.

8. The handle set forth in claim 1, wherein the arm receiving apparatus includes a fastenable strap having overlapping ends encircling the forearm of the user adjacent the elbow that can be pulled tightly about the forearm.

9. The handle set forth in claim 8, wherein the arm receiving apparatus includes an arcuate arm rest fixed intermediate the ends of the frame and having upwardly extending free ends for carrying the strap.

10. The handle set forth in claim 1, further including: an extension member having a shank with a multi-faceted external surface at one end; a bushing in the other end of the frame extension opposite the shank having a multi-faceted internal surface corresponding to the external facets of the implement shank; and an interlocking apparatus extending through the extension member and into the implement shank avoiding relative rotation and longitudinal movement between the implement and the extension member.

11. The handle set forth in claim 10, wherein the multi-faceted external surfaces of the extension member shank have openings for receiving the interlocking apparatus for fixing the extension member shank in multiple angular positions relative to the frame.

12. The method of manually operating an implement having an aligned shank comprising the steps of:
utilizing a single straight length of a tubing to form an elongated frame;
extending the length of the elongated frame by engaging an extension member in one end of the elongated frame in axial alignment therewith against rotation and relative longitudinal movement;
engaging the aligned implement shank in one end of the extension member opposite the elongated frame in axial alignment therewith against rotation and relative longitudinal movement;
engaging an upright hand grip carried by the elongated frame in spaced relation to the implement by the hand of the user;
mounting a support slidably encircling the straight length of tubing at the other end of the frame remote from the implement for adjustably positioning the support longitudinally on the frame; and
encompassing the arm of a user by a receiving member adjacent to and below the elbow of the user carried by the support in axial alignment with the hand grip and with the shank;

13. The method of manually operating an implement set forth in claim 12, including the step of providing adjustable stops for adjustably fixing the angular position of the shank against rotation within the tubular frame.

14. The method of manually operating an implement set forth n claim 12, further including the step of slidably mounting the support on the tubular frame.
